(19) United States
(12) Patent Application Publication
(10) Pub. No.: US 2017/0017327 A1
(43) Pub. Date: Jan. 19, 2017

(54) TOUCH DISPLAY DEVICE

(71) Applicant: InnoLux Corporation, Miao-Li County (TW)

(72) Inventors: Chih-Hao CHANG, Miao-Li County (TW); Bo-Feng CHEN, Miao-Li County (TW); Chia-Hao TSAI, Miao-Li County (TW); Tung-Kai LIU, Miao-Li County (TW); Jen-Chieh PENG, Miao-Li County (TW)

(21) Appl. No.: 15/212,048

(22) Filed: Jul. 15, 2016

Related U.S. Application Data
(60) Provisional application No. 62/193,787, filed on Jul. 17, 2015.

(30) Foreign Application Priority Data
Feb. 4, 2016 (TW) 105103703

(51) Int. Cl. G06F 3/041; G06F 3/044

(52) U.S. Cl. CPC G06F 3/0412; G06F 3/044; G06F 2203/04107

(57) ABSTRACT

A touch display device is provided. The touch display device includes a first substrate; a transistor disposed over the first substrate; a first insulating layer disposed over the transistor; a first electrode disposed over the first insulating layer; a second insulating layer disposed over the first electrode; a conductive layer disposed over the second insulating layer, wherein the conductive layer includes a touch signal line; a third insulating layer disposed over the conductive layer; and a second electrode disposed over the third insulating layer, wherein one of the first electrode and the second electrode is electrically connected to the touch signal line, wherein another one of the first electrode and the second electrode is electrically connected to the transistor and at least partially overlaps the conductive layer.

### CROSS REFERENCE TO RELATED APPLICATIONS

This application claims priority of Taiwan Patent Application No. 105103703, filed on Feb. 4, 2016, which claims the benefit of priority from a provisional application of, U.S. Patent Application No. 62/193,787 filed on Jul. 17, 2015 and the entirety of which is incorporated by reference herein.

### BACKGROUND OF THE INVENTION

Field of the Invention

The embodiments of the disclosure relate to a touch display device, and in particular to a touch display device with a touch signal line disposed over the array substrate.

Description of the Related Art

As technologies have progressed, various novel information apparatuses, such as cell phones, tablet computers, ultrabooks, and GPS navigation apparatuses, have been invented. Generally, a keyboard and a mouse are commonly used to manipulate the information apparatus for inputting information. Nevertheless, touch control technology is currently also a popular manipulation method for information apparatuses with an intuitive operation. Accordingly, a touch display device using touch control technology can provide a friendly and intuitive interface for input operations, while a user in any age group can manipulate the touch display apparatus using fingers or a stylus.

However, existing touch display devices have not been satisfactory in every respect. For example, the storage capacitor of a touch display device refers to the capacitor between the pixel electrode and the common electrode of the touch display device. When the resolution of the touch display devices increases, if the storage capacitor is insufficient, the display quality of the touch display device may suffer.

Therefore, a touch display device which may further increase the storage capacitor and reduce the risk of affecting the display quality of the touch display device is needed.

### BRIEF SUMMARY OF THE INVENTION

The present disclosure provides a touch display device, including: a first substrate; a transistor disposed over the first substrate; a first insulating layer disposed over the transistor; a first electrode disposed over the first insulating layer; a second insulating layer disposed over the first electrode; a conductive layer disposed over the second insulating layer, wherein the conductive layer includes a touch signal line; a third insulating layer disposed over the conductive layer; and a second electrode disposed over the third insulating layer, wherein one of the first electrode and the second electrode is electrically connected to the touch signal line, wherein another one of the first electrode and the second electrode is electrically connected to the transistor and at least partially overlaps the conductive layer.

A detailed description is given in the following embodiments with reference to the accompanying drawings.

### BRIEF DESCRIPTION OF THE DRAWINGS

The disclosure may be more fully understood by reading the subsequent detailed description and examples with references made to the accompanying drawings, wherein:

FIG. 1A is a top view of a touch display device in accordance with some embodiments of the present disclosure;

FIG. 1B is a cross-sectional view along line 1B-1B′ in FIG. 1A in accordance with some embodiments of the present disclosure;

FIG. 1C is a cross-sectional view along line 1C-1C′ in FIG. 1A in accordance with some embodiments of the present disclosure;

FIG. 1D is a cross-sectional view along line 1D-1D′ in FIG. 1A in accordance with some embodiments of the present disclosure;

FIG. 2 is a top view of a touch display device in accordance with some embodiments of the present disclosure;

FIG. 3A is a top view of a touch display device in accordance with some embodiments of the present disclosure;

FIG. 3B is a cross-sectional view along line 3B-3B′ in FIG. 3A in accordance with some embodiments of the present disclosure;

FIG. 3C is a cross-sectional view along line 3C-3C′ in FIG. 3A in accordance with some embodiments of the present disclosure;

FIG. 3D is a cross-sectional view along line 3D-3D′ in FIG. 3A in accordance with some embodiments of the present disclosure;

FIG. 4A is a top view of a touch display device in accordance with some embodiments of the present disclosure;

FIG. 4B is a cross-sectional view along line 4B-4B′ in FIG. 4A in accordance with some embodiments of the present disclosure;

FIG. 4C is a cross-sectional view along line 4C-4C′ in FIG. 4A in accordance with some embodiments of the present disclosure;

FIG. 5A is a top view of a touch display device in accordance with some embodiments of the present disclosure;

FIG. 5B is a cross-sectional view along line 5B-5B′ in FIG. 5A in accordance with some embodiments of the present disclosure;

FIG. 6A is a top view of a touch display device in accordance with some embodiments of the present disclosure;

FIG. 6B is a cross-sectional view along line 6B-6B′ in FIG. 6A in accordance with some embodiments of the present disclosure; and

FIG. 6C is a cross-sectional view along line 6C-6C′ in FIG. 6A in accordance with some embodiments of the present disclosure.

### DETAILED DESCRIPTION OF THE INVENTION

The touch display device of the present disclosure is described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. In addition, in this specification, expressions such as “first material layer disposed on/over a second material layer”, may indicate the direct contact of the first material layer and the second material layer, or it may indicate a non-contact state with one or more intermediate layers between the first material layer and the second material layer. In the above situation, the first material layer may not be in direct contact with the second material layer.

It should be noted that the elements or devices in the drawings of the present disclosure may be present in any form or configuration known to those skilled in the art. In addition, the expression “a layer overlying another layer”, “a layer is disposed above another layer”, “a layer is disposed on another layer” and “a layer is disposed over another layer” may indicate that the layer is in direct contact with the other layer, or that the layer is not in direct contact with the other layer, there being one or more intermediate layers disposed between the layer and the other layer.

In addition, in this specification, relative expressions are used. For example, “lower”, “bottom”, “higher” or “top” are used to describe the position of one element relative to another. It should be appreciated that if a device is flipped upside down, an element that is “lower” will become an element that is “higher”.

The terms “about” and “substantially” typically mean+/−20% of the stated value, more typically+/−10% of the stated value, more typically+/−5% of the stated value, more typically+/−3% of the stated value, more typically+/−2% of the stated value, more typically+/−1% of the stated value and even more typically+/−0.5% of the stated value. The stated value of the present disclosure is an approximate value. When there is no specific description, the stated value includes the meaning of “about” or “substantially”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another region, layer or section. Thus, a first element, component, region, layer, portion or section discussed below could be termed a second element, component, region, layer, portion or section without departing from the teachings of the present disclosure.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

This description of the exemplary embodiments is intended to be read in connection with the accompanying drawings, which are to be considered part of the entire written description. The drawings are not drawn to scale. In addition, structures and devices are shown schematically in order to simplify the drawing.

In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

The term “substrate” is meant to include devices formed within a transparent substrate and the layers overlying the transparent substrate. All transistor element needed may be already formed over the substrate. However, the substrate is represented with a flat surface in order to simplify the drawing. The term “substrate surface” is meant to include the uppermost exposed layers on a transparent substrate, such as an insulating layer and/or metallurgy lines.

The storage capacitor of the touch display devices refers to the capacitor between the pixel electrode and the common electrode of the touch display devices. When the resolution of the touch display devices increases, the size of pixel decreases. If the storage capacitor is insufficient or too small, when the pixel is in the charge-holding state, the pixel electrical potential (or the liquid crystal electrical potential) would change due to the small leakage current of the transistor, which in turn changes the display brightness and results in flickering of the display. In addition, if the storage capacitor is insufficient or too small, the capacitor coupling effect of the pixel would be excessive, which in turn deteriorates the display quality of the touch display devices and may also result in flickering of the display.

Accordingly, since the touch signal line of the touch display device is electrically connected to the common electrode, the touch signal line may be viewed as an extending portion of the common electrode. Therefore, by having the touch signal line overlap the pixel electrode, according to some embodiments, the storage capacitor can be increased, and the risk of inferior display quality of the touch display device can be reduced.

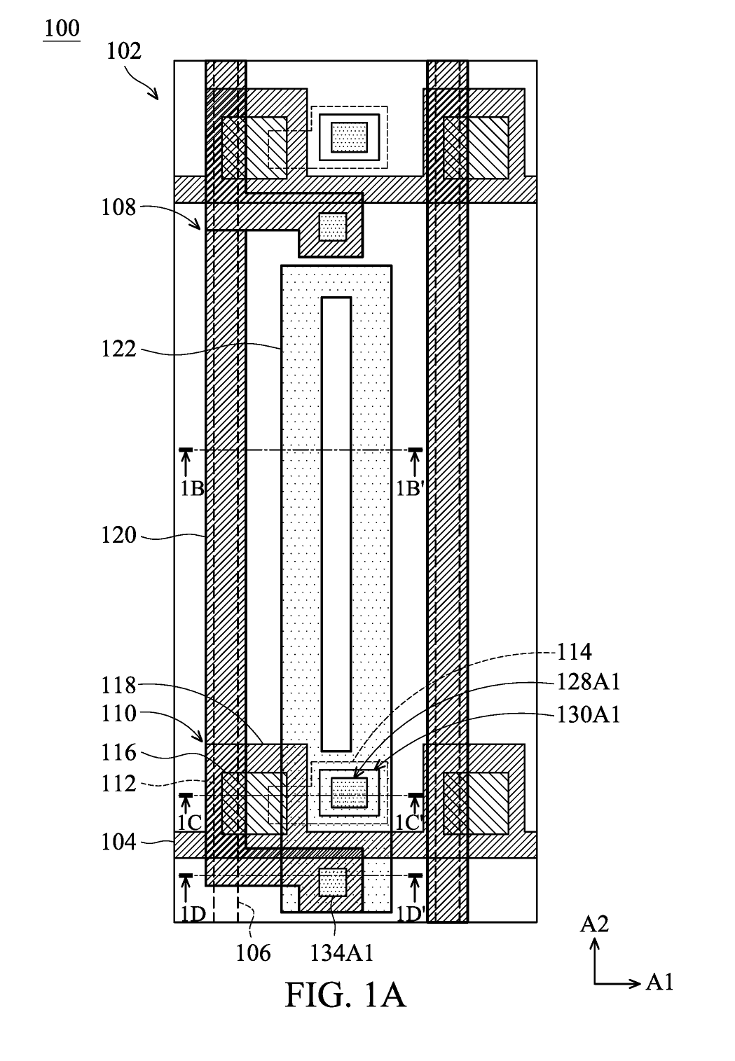

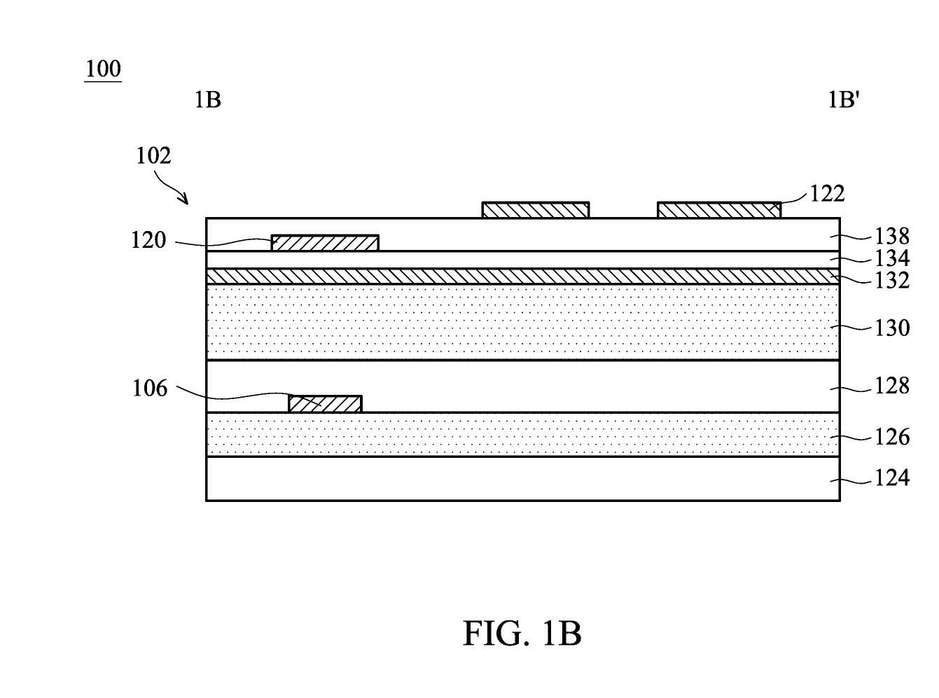

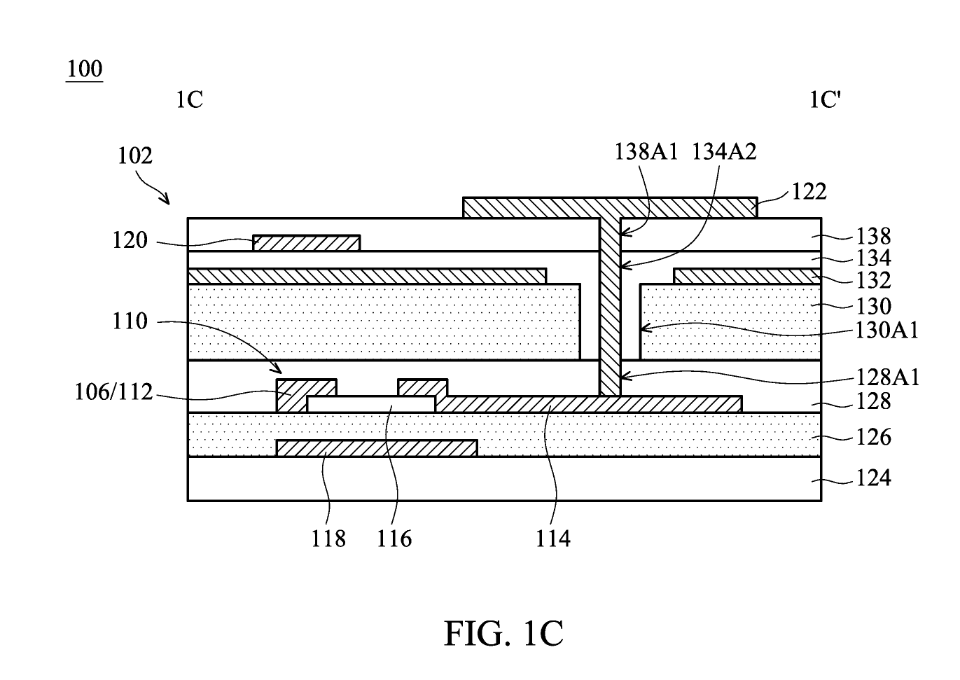

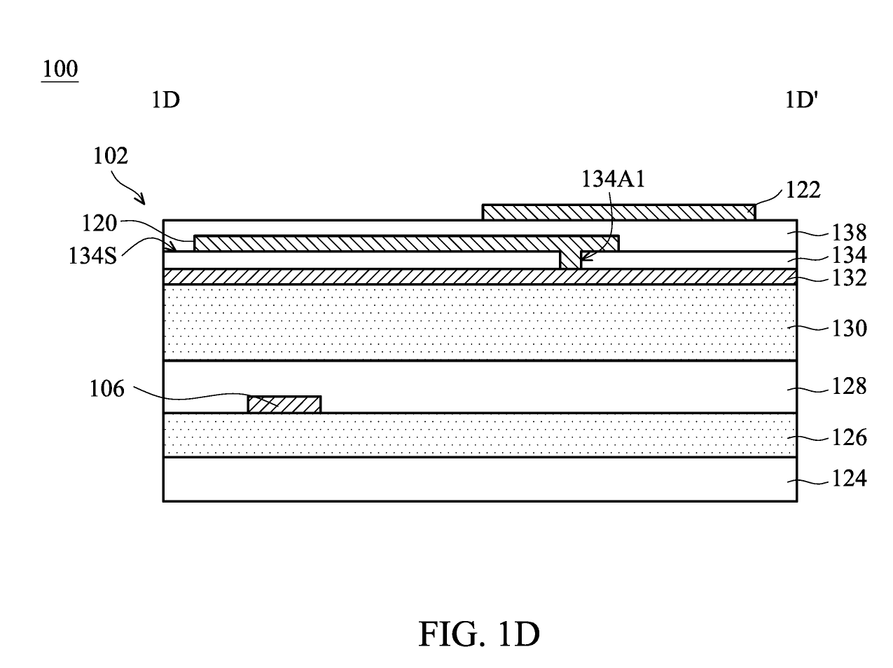

FIG. 1A is a top view of an array substrate 102 of the touch display device 100 in accordance with some embodiments of the present disclosure. Referring to FIG. 1A, the array substrate 102 may include a scan line (gate line) 104, which extends along a first direction A1. The array substrate 102 may further include a data line 106, which intersects the scan line 104. In other words, the gate line 104 extends along direction A1, and the direction A2 refers to a direction that is substantially perpendicular or orthogonal to the scan-line (or gate-line) extending direction A1. In addition, the array substrate 102 may further include thin film transistors 110 corresponding to each sub-pixel 108.

The display device 100 may include, but is not limited to, a touch liquid-crystal display such as a thin film transistor liquid-crystal display. The liquid-crystal display may include, but is not limited to, a twisted nematic (TN) liquid-crystal display, a super twisted nematic (STN) liquid-crystal display, a double layer super twisted nematic (DSTN) liquid-crystal display, a vertical alignment (VA) liquid-crystal display, an in-plane switching (IPS) liquid-crystal display, a cholesteric liquid-crystal display, a blue phase liquid-crystal display, fringe field switching liquid-crystal display, or any other suitable liquid-crystal display.

The array substrate 102 may include a transistor substrate. The data line 106 may provide the signal to the sub-pixels 108 through the transistors 110. The scan line (gate line) 104 may provide the scanning pulse signal to the sub-pixels 108 through the transistors 110 and control the sub-pixels 108 in coordination with the aforementioned signal.

The transistor 110 includes a source electrode 112, a drain electrode 114, a semiconductor layer 116 between the source electrode 112 and drain electrode 114, and a gate electrode 118. The gate electrode 118 extends from the scan line 104 along the second direction A2. The source electrode 112 is a portion of the data line 106.

The array substrate 102 may further include a conductive layer 120. In some embodiments of the present disclosure, the conductive layer 120 is a touch signal line 120. The touch signal line 120 substantially overlaps the data line 106, and is electrically connected to the common electrode of the touch display device 100 (not shown in FIG. 1A, referring to subsequent FIGS. 1B-1D). In addition, the array substrate 102 may further include a pixel electrode 122. The pixel electrode 122 may be electrically connected to the drain electrode 114 of the transistors 110.

It should be noted that, the subsequent common electrode is not shown in FIG. 1A in order to clearly describe the embodiments of the present disclosure.

In addition, as shown in FIG. 1A, the touch signal line 120 at least partially overlaps the pixel electrode 122. Since the touch signal line 120 of the touch display device 100 is electrically connected to the common electrode, the touch signal line 120 may be viewed as an extending portion of the common electrode. Therefore, by having the touch signal line 120 at least partially overlap the pixel electrode 122, according to some embodiments, in the touch display device 100, the storage capacitor between the pixel electrode 122 and the common electrode can be increased, thus reducing the risk of inferior display quality.

FIGS. 1B-1D are cross-sectional views of the touch display device 100 in accordance with some embodiments of the present disclosure. FIG. 1B is a cross-sectional view along line 1B-1B′ in FIG. 1A in accordance with some embodiments of the present disclosure. FIG. 1C is a cross-sectional view along line 1C-1C′ in FIG. 1A in accordance with some embodiments of the present disclosure. FIG. 1D is a cross-sectional view along line 1D-1D′ in FIG. 1A in accordance with some embodiments of the present disclosure. As shown in FIG. 1C, the array substrate 102 may include a first substrate 124. The first substrate 124 may include, but is not limited to, a transparent substrate, such as a glass substrate, a ceramic substrate, a plastic substrate, or any other suitable transparent substrate. The transistor 110 is disposed over the first substrate 124. The transistor 110 may include thin film transistor. The transistor 110 includes a gate electrode 118 disposed over the first substrate 124 and a gate dielectric layer 126 disposed over the gate electrode 118 and the first substrate 124.

The material of the gate electrode 118 may include, but is not limited to, amorphous silicon, poly-silicon, one or more metal, metal nitride, conductive metal oxide, or a combination thereof. The metal may include, but is not limited to, molybdenum, tungsten, titanium, tantalum, platinum, or hafnium. The metal nitride may include, but is not limited to, molybdenum nitride, tungsten nitride, titanium nitride or tantalum nitride. The conductive metal oxide may include, but is not limited to, ruthenium oxide or indium tin oxide. The gate electrode 118 may be formed by the previously described chemical vapor deposition (CVD), sputtering, resistive thermal evaporation, electron beam evaporation, or any other suitable methods. For example, in one embodiment, the amorphous silicon conductive material layer or poly-silicon conductive material layer may be deposited and formed by low-pressure chemical vapor deposition at about 525° C.˜650° C. The thickness of the amorphous silicon conductive material layer or poly-silicon conductive material layer may range from about 1000 Å to 10000 Å.

The material of the gate dielectric layer 126 may include, but is not limited to, silicon oxide, silicon nitride, silicon oxynitride, high-k material, any other suitable dielectric material, or a combination thereof. The high-k material may include, but is not limited to, metal oxide, metal nitride, metal silicide, transition metal oxide, transition metal nitride, transition metal silicide, transition metal oxynitride, metal aluminate, zirconium silicate, zirconium aluminate. For example, the material of the high-k material may include, but is not limited to, LaO, AlO, ZrO, TiO, Ta₂O₅, Y₂O₃, SrTiO₃(STO), BaTiO₃(BTO), BaZrO, HfO₂, HfO₃, HfZrO, HfLaO, HfSiO, HfSiON, LaSiO, AlSiO, HfTaO, HfTiO, HfTaTiO, HfAlON, (Ba,Sr)TiO₃(BST), Al₂O₃, any other suitable high-k dielectric material, or a combination thereof. The gate dielectric layer 126 may be formed by chemical vapor deposition or spin-on coating. The chemical vapor deposition may include, but is not limited to, low pressure chemical vapor deposition (LPCVD), low temperature chemical vapor deposition (LTCVD), rapid thermal chemical vapor deposition (RTCVD), plasma enhanced chemical vapor deposition (PECVD), atomic layer deposition (ALD), or any other suitable method.

The transistor 110 can further include a semiconductor layer 116 disposed over the gate dielectric layer 126. The semiconductor layer 116 overlaps the gate electrode 118. The source electrode 112 and drain electrode 114 are disposed at opposite sides of the semiconductor layer 116, respectively. The source electrode 112 and drain electrode 114 overlap the portions of the semiconductor layer 116 at the opposite sides, respectively.

The semiconductor layer 116 may include an element semiconductor which may include silicon, germanium; a compound semiconductor which may include gallium nitride (GaN), silicon carbide, gallium arsenide, gallium phosphide, indium phosphide, indium arsenide and/or indium antimonide; an alloy semiconductor which may include SiGe alloy, GaAsP alloy, AlInAs alloy, AlGaAs alloy, GaInAs alloy, GaInP alloy and/or GaInAsP alloy; metal oxide, such as IGZO (indium gallium zinc oxide); or a combination thereof.

The source electrode 112 and drain electrode 114 may include, but is not limited to, copper, aluminum, molybdenum, tungsten, gold, cobalt, nickel, platinum, titanium, iridium, rhodium, an alloy thereof, a combination thereof, or any other conductive material. For example, the source electrode 112 and drain electrode 114 may include three-layered structure such as Mo/Al/Mo or Ti/Al/Ti. In other embodiments, the source electrode 112 and drain electrode 114 includes a nonmetal material. The source electrode 112 and drain electrode 114 may include any conductive material. The material of the source electrode 112 and drain electrode 114 may be formed by chemical vapor deposition (CVD), sputtering, resistive thermal evaporation, electron beam evaporation, or any other suitable method. In some embodiments, the materials of the source electrode 112 and drain electrode 114 may be the same, and the source electrode 112 and drain electrode 114 may be formed by the same deposition steps. However, in other embodiments, the source electrode 112 and drain electrode 114 may be formed by different deposition steps, and the materials of the source electrode 112 and drain electrode 114 may be different from each other.

Still referring to FIG. 1B, the array substrate 102 can further include a first insulating layer 128 covering the transistor 110 and gate dielectric layer 126 and disposed over the first substrate 124. In other words, the first insulating layer 128 is disposed over the transistor 110. The material of the first insulating layer 128 may include, but is not limited to, silicon nitride, silicon oxide, or silicon oxynitride. The first insulating layer 128 may be formed by chemical vapor deposition or spin-on coating. The chemical vapor deposition may include, but is not limited to, low pressure chemical vapor deposition (LPCVD), low temperature chemical vapor deposition (LTCVD), rapid thermal chemical vapor deposition (RTCVD), plasma enhanced chemical vapor deposition (PECVD), atomic layer deposition (ALD), or any other suitable method.

Subsequently, a planar layer 130 may be optionally disposed over the first insulating layer 128. The planar layer 130 may be an insulating layer. The material of the planar layer 130 may include, but is not limited to, organic insulating materials (such as photosensitive resins) or inorganic insulating materials (such as silicon nitride, silicon oxide, silicon oxynitride, silicon carbide, aluminum oxide, or a combination thereof). In addition, the planar layer 130 may be disposed between the first insulating layer 128 and the subsequent second insulating layer. In some embodiments of the present disclosure, the planar layer 130 and first insulating layer 128 may be etched by two etching steps respectively to form an opening 130A1 in the planar layer 130 and an opening 128A1 in the first insulating layer 128.

Referring to FIGS. 1B-1D, the array substrate 102 can further include a common electrode 132 disposed over the planar layer 130 (or the first insulating layer 128). The material of the common electrode 132 may include, but is not limited to, transparent conductive material such as indium tin oxide (ITO), tin oxide (SnO), indium zinc oxide (IZO), indium gallium zinc oxide (IGZO), indium tin zinc oxide (ITZO), antimony tin oxide (ATO), antimony zinc oxide (AZO), a combination thereof, or any other suitable transparent conductive oxide.

Still referring to FIGS. 1B-1D, the display device 100 can further include a second insulating layer 134 disposed over the planar layer 130 (or the first insulating layer 128) and covering the common electrode 132. In other words, the second insulating layer 134 is disposed over the common electrode 132. The material of the second insulating layer 134 may include, but is not limited to, silicon nitride, silicon oxide, or silicon oxynitride. The planar layer 130 is disposed between the first insulating layer 128 and the second insulating layer 134. Referring to FIG. 1D, the second insulating layer 134 has an opening 134A1. The opening 134A1 extends downward from the top surface 134S of the second insulating layer 134 to the common electrode 132.

Subsequently, the conductive layer 120 is disposed over the second insulating layer 134. In this embodiment, the conductive layer 120 may include a touch signal line 120. The touch signal line 120 is electrically connected to the common electrode 132 through the opening 134A1.

The touch signal line 120 may include, but is not limited to, copper, aluminum, molybdenum, tungsten, gold, cobalt, nickel, platinum, titanium, iridium, rhodium, an alloy thereof, a combination thereof, or any other conductive material. For example, the touch signal line 120 may include three-layered structure such as Mo/Al/Mo or Ti/Al/Ti. In other embodiments, the touch signal line 120 includes a nonmetal material. The touch signal line 120 may include any conductive material. The material of the touch signal line 120 may be formed by chemical vapor deposition (CVD), sputtering, resistive thermal evaporation, electron beam evaporation, or any other suitable method.

In addition, since the common electrode 132 is electrically connected to the touch signal line 120, the common electrode 132 not only serves as the common electrode, but also serves as the sensing electrode of the display device when the display device 100 is touched. In some embodiments, the driving method for touch-control can be the self-capacitive type or the mutual capacitive type.

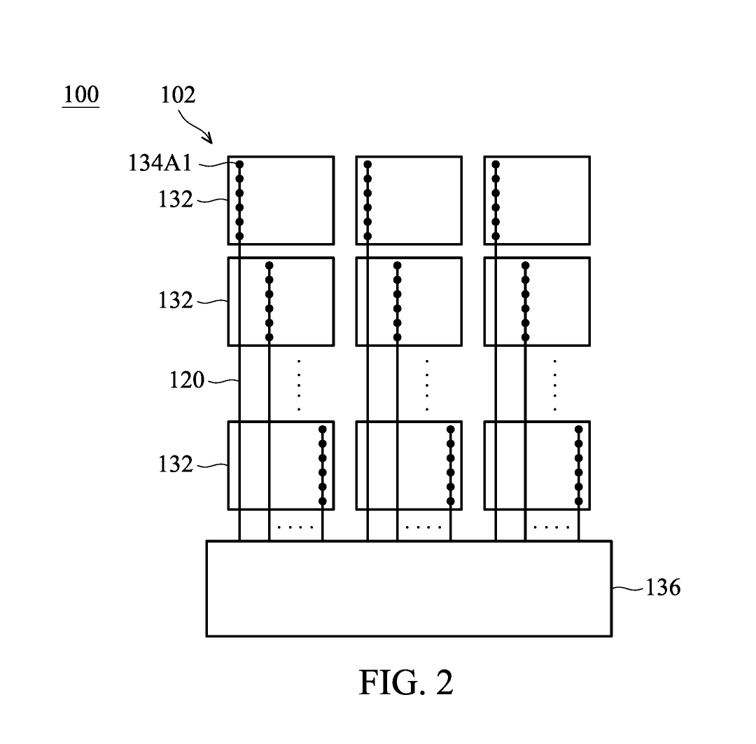

FIG. 2 is a top view of an array substrate 102 of the touch display device 100 in accordance with some embodiments of the present disclosure. As shown in FIG. 2, the common electrode 132 is electrically connected to the touch signal line 120 through the opening 134A1, and is electrically connected to the driving element 136 through the touch signal line 120. The driving element 136 may simply be a touch-control driving element 136, or may be a driving element 136 which integrates display driving element and touch-control driving element.

Still referring to FIGS. 1B-1D, the display device 100 can further include a third insulating layer 138 disposed over the second insulating layer 134 and covering the touch signal line 120. In other words, the third insulating layer 138 is disposed over the touch signal line 120. The material of the third insulating layer 138 may include, but is not limited to, silicon nitride, silicon oxide, or silicon oxynitride.

Still referring to FIGS. 1B-1D, the display device 100 can further include a pixel electrode 122 disposed over the third insulating layer 138 and electrically connected to the transistor 110. The material of the pixel electrode 122 may include, but is not limited to, transparent conductive material such as indium tin oxide (ITO), tin oxide (SnO), indium zinc oxide (IZO), indium gallium zinc oxide (IGZO), indium tin zinc oxide (ITZO), antimony tin oxide (ATO), antimony zinc oxide (AZO), a combination thereof, or any other suitable transparent conductive oxide.

In addition, as shown in FIG. 1C, the array substrate 102 can further include an opening 134A2 disposed in the second insulating layer 134 and an opening 138A1 disposed in the third insulating layer 138. The pixel electrode 122 is electrically connected to the drain electrode 114 of the transistors 110 through the openings 138A1, 134A2 and 128A1.

In addition, as shown in FIG. 1D, the common electrode 132 is electrically connected to the touch signal line 120. As shown in FIGS. 1A and 1C-1D, the pixel electrode 122 is electrically connected to the transistor 110 and at least partially overlaps the conductive layer 120 (for example, the touch signal line 120).

In addition, referring to FIG. 1D, there are two insulating layers (i.e. the second insulating layer 134 and the third insulating layer 138) between the pixel electrode 122 and the common electrode 132. In comparison, there is only one insulating layer (i.e. the third insulating layer 138) between the pixel electrode 122 and the touch signal line 120. Therefore, the distance between the pixel electrode 122 and the touch signal line 120 is smaller than that between the pixel electrode 122 and the common electrode 132. Since the shorter distance may produce the larger storage capacitor, compared to the pixel electrode 122 and the common electrode 132, the pixel electrode 122 and the touch signal line 120 which are closer to each other may greatly increase the storage capacitor of the device and reduce the risk of deteriorating the display quality of the touch display device. For example, in some embodiments of the present disclosure, having the pixel electrode 122 at least partially overlaps the touch signal line 120 (or the conductive layer 120) may greatly increase the storage capacitor from 90fF to 143fF.

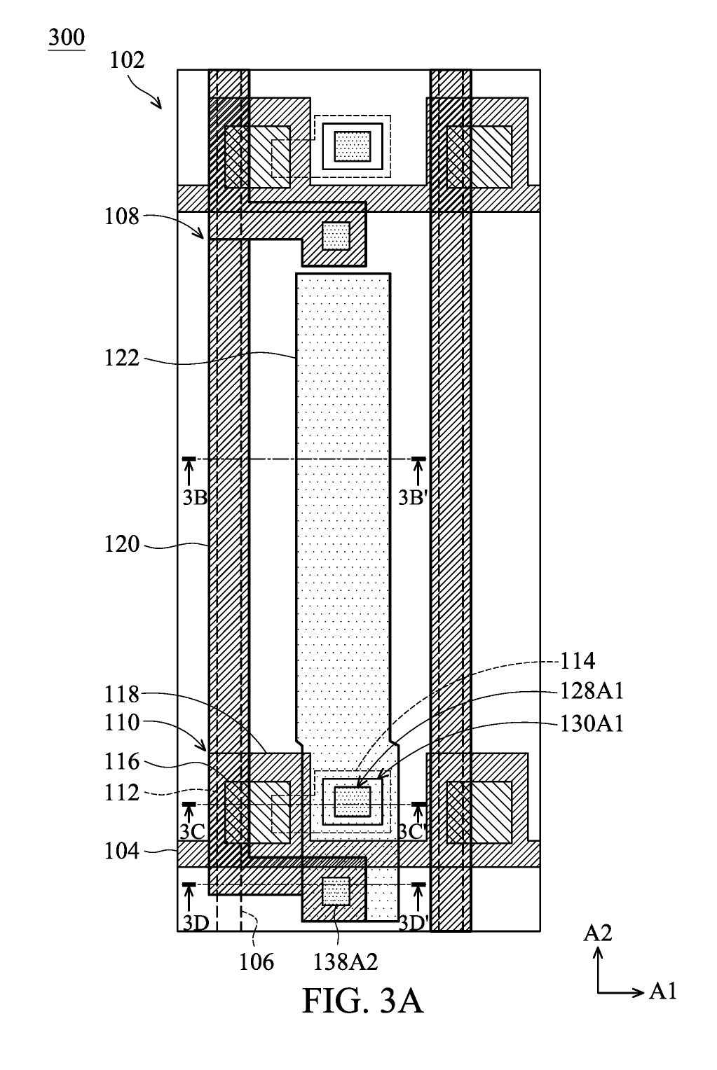

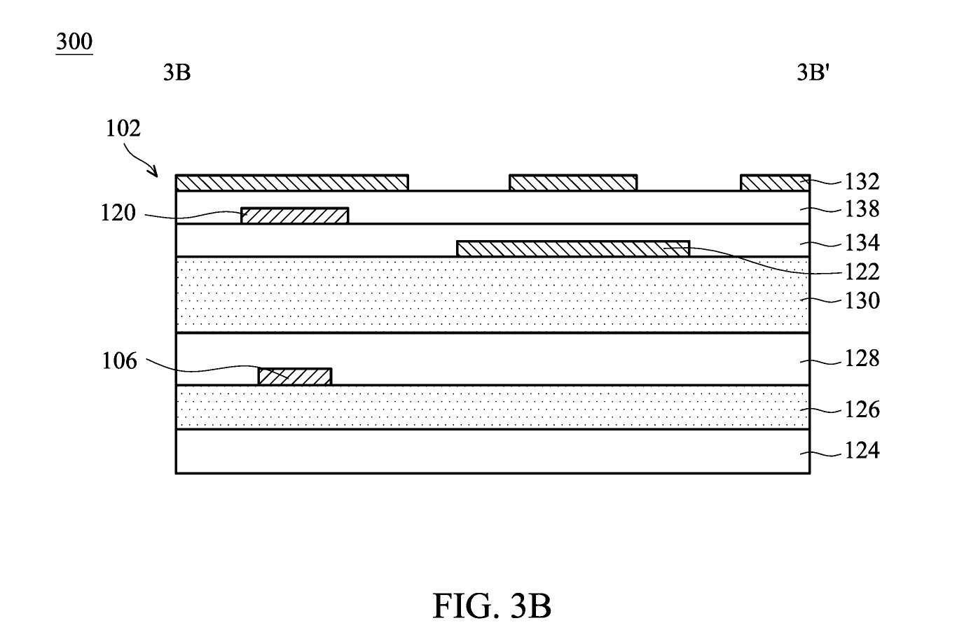

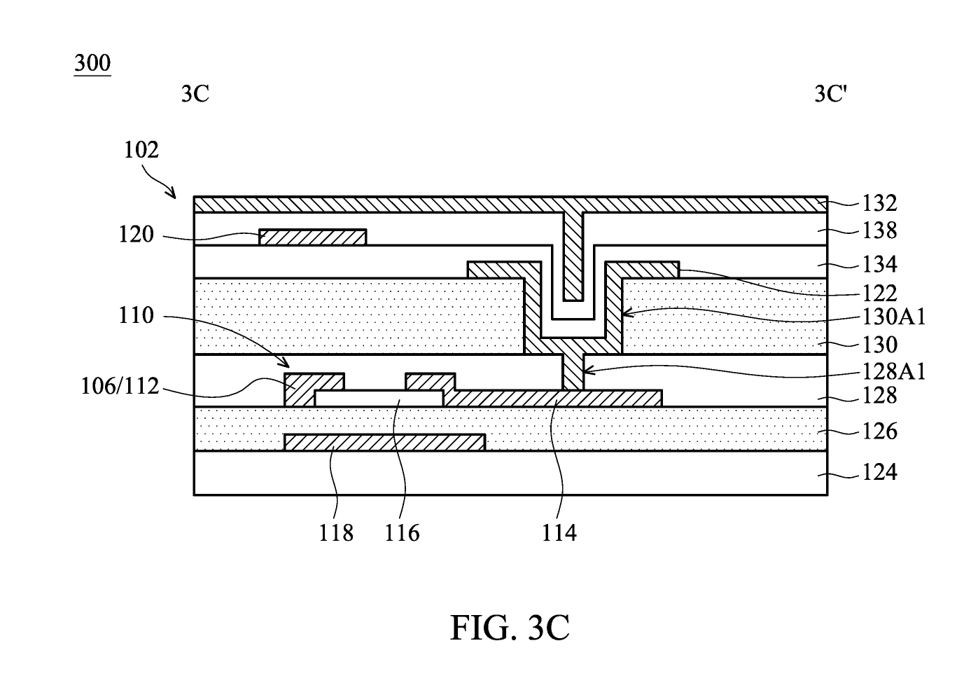

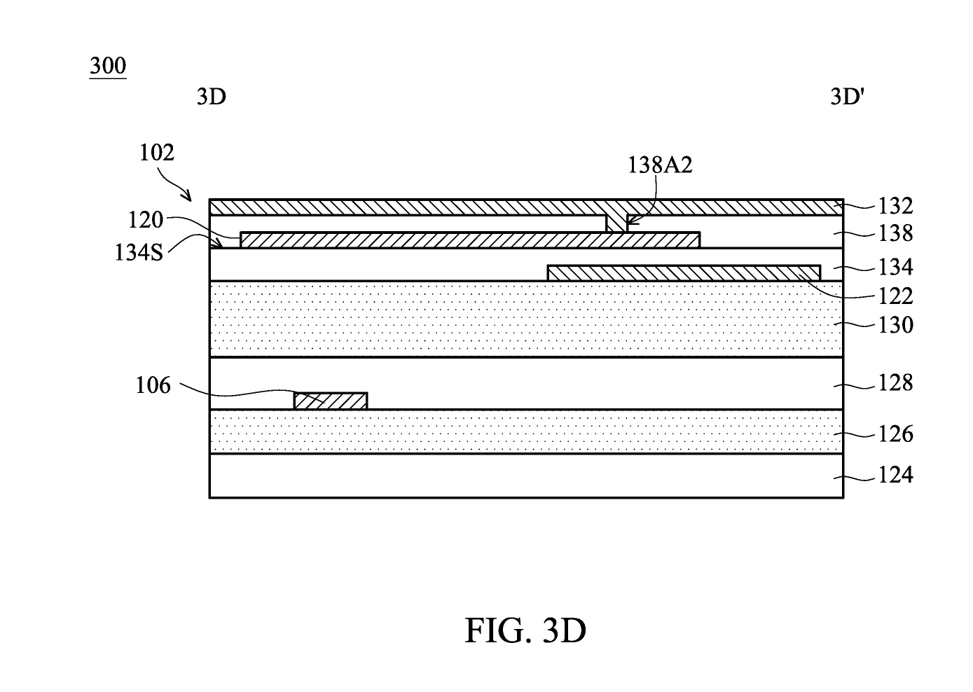

It should be noted that the exemplary embodiments set forth in FIGS. 1A-1D are merely for the purpose of illustration. In addition to the embodiments set forth in FIGS. 1A-1D, the pixel electrode and common electrode of the present disclosure may have other configurations as shown in FIGS. 3A-3D. This will be described in detail in the following description. Therefore, the inventive concept and scope are not limited to the exemplary embodiments shown in FIGS. 1A-1D.

Note that the same or similar elements or layers corresponding to those of the semiconductor device are denoted by like reference numerals. The same or similar elements or layers denoted by like reference numerals have the same meaning and will not be repeated for the sake of brevity.

FIG. 3A is a top view of an array substrate 102 of the touch display device 300 in accordance with some embodiments of the present disclosure. FIG. 3B is a cross-sectional view along line 3B-3B′ in FIG. 3A in accordance with some embodiments of the present disclosure. FIG. 3C is a cross-sectional view along line 3C-3C′ in FIG. 3A in accordance with some embodiments of the present disclosure. FIG. 3D is a cross-sectional view along line 3D-3D′ in FIG. 3A in accordance with some embodiments of the present disclosure. As shown in FIGS. 3B-3D, the pixel electrode 122 of the touch display device 300 is disposed over the planar layer 130 (or the first insulating layer 128). The pixel electrode 122 extends into the openings 130A1 and 128A1 and is electrically connected to the drain electrode 114 of the transistors 110.

Still referring to FIGS. 3B-3D, the display device 300 can further include a second insulating layer 134 disposed over the planar layer 130 (or the first insulating layer 128) and covering the pixel electrode 122. The planar layer 130 is disposed between the first insulating layer 128 and the second insulating layer 134.

Still referring to FIGS. 3B-3D, the touch signal line 120 (or the conductive layer 120) is disposed over the second insulating layer 134. Subsequently, the display device 300 further includes a third insulating layer 138 disposed over the second insulating layer 134 and covering the touch signal line 120. The third insulating layer 138 has an opening 138A2 exposing the touch signal line 120, as shown in FIG. 3D.

The display device 300 can further include a common electrode 132 disposed over the third insulating layer 138 and electrically connected to the touch signal line 120. In particular, the common electrode 132 is disposed over the third insulating layer 138 and is electrically connected to the touch signal line 120 through the opening 138A2. The common electrode 132 not only serves as the common electrode of the display device, but also serves as the sensing electrode of the display device when the display device is touched.

The difference between the embodiments shown in FIGS. 3A-3D and 1A-1D is that the common electrode 132 is disposed over the pixel electrode 122. In addition, the same part of the embodiments shown in FIGS. 3A-3D and 1A-1D is that the common electrode 132 is electrically connected to the touch signal line 120, and the pixel electrode 122 is electrically connected to the transistor 110 and at least partially overlaps the conductive layer 120, as shown in FIGS. 3A-3D.

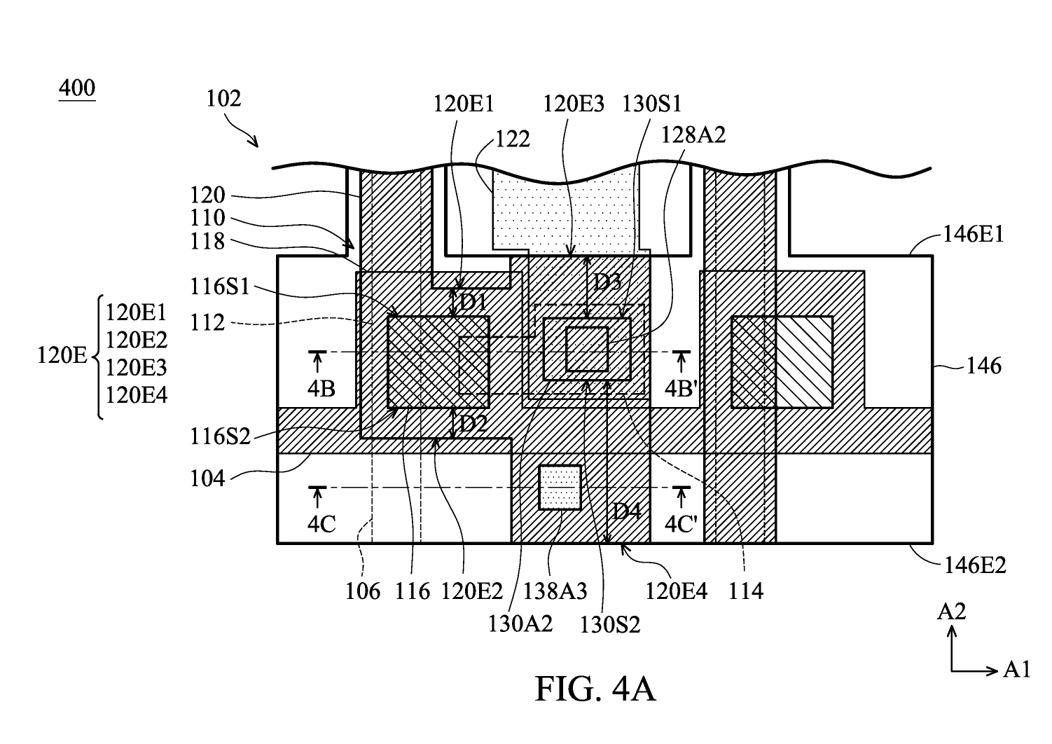

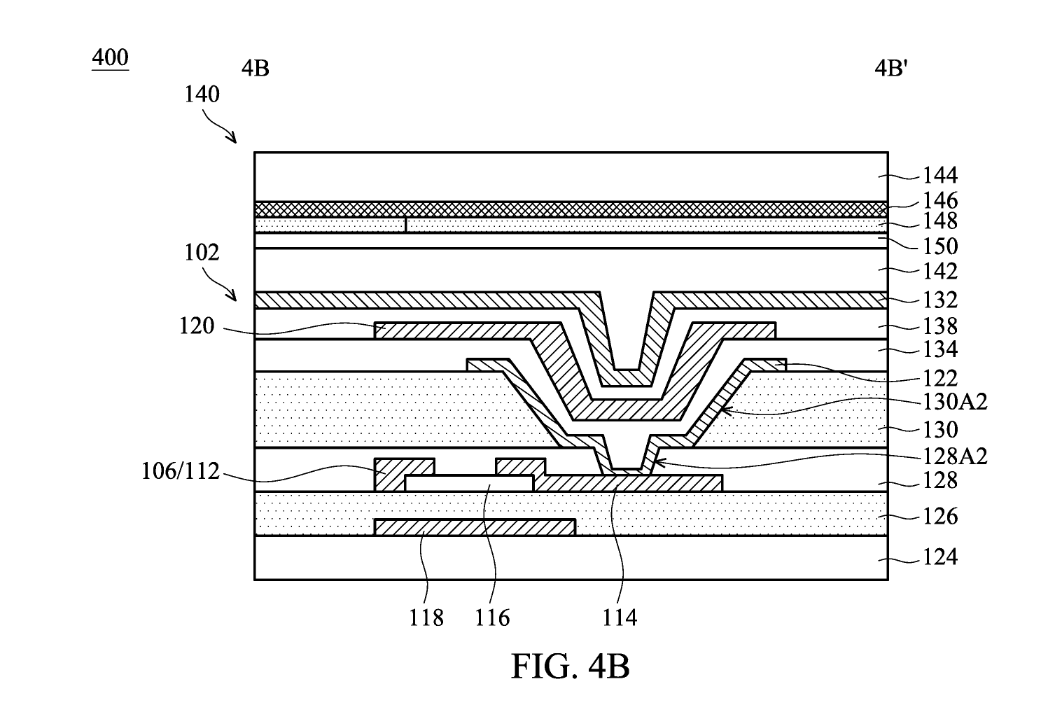

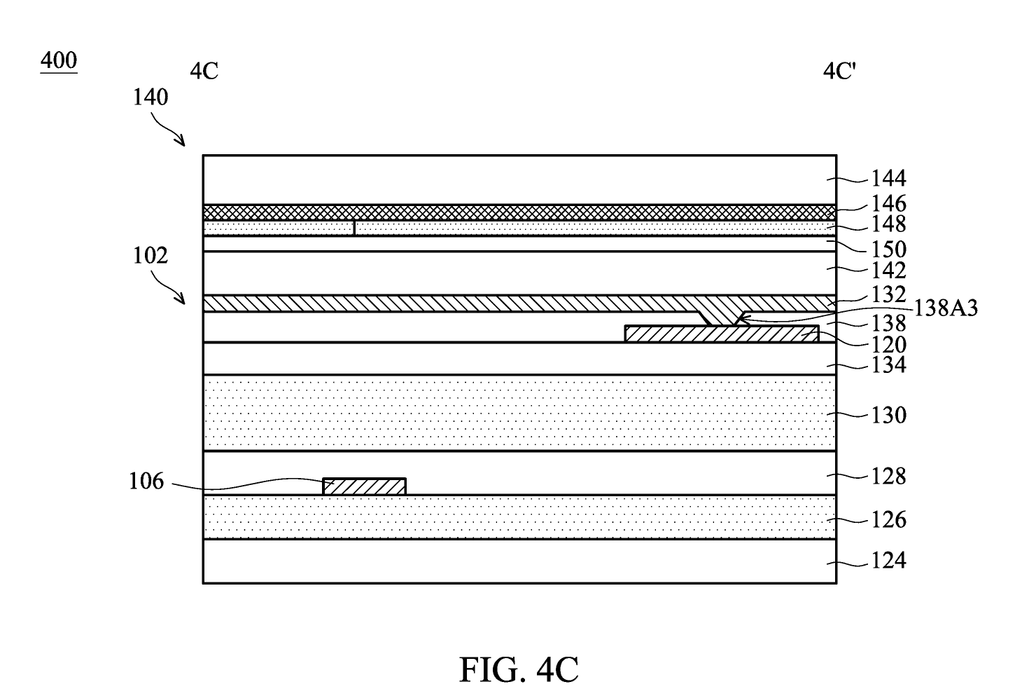

FIG. 4A is a top view of an array substrate 102 of the touch display device 400 in accordance with some embodiments of the present disclosure. FIG. 4B is a cross-sectional view along line 4B-4B′ in FIG. 4A in accordance with some embodiments of the present disclosure. FIG. 4C is a cross-sectional view along line 4C-4C′ in FIG. 4A in accordance with some embodiments of the present disclosure. As shown in FIG. 4A, in some embodiments of the present disclosure, the touch signal line 120 may at least partially overlap the transistor 110. For example, the touch signal line 120 may at least partially overlap the semiconductor layer 116 in the transistor 110.

In the conventional display device, a light-shielding layer disposed over another substrate which is disposed opposite the first substrate (for example, the subsequent light-shielding layer 146 disposed over the second substrate 140) is used to shield the semiconductor layer of the transistor. However, in order to ensure that the light-shielding layer may shield the semiconductor layer of the transistor, the error of assembly between the first substrate and another substrate must be taken into consideration when deciding the area of the light-shielding layer. Therefore, the area of the light-shielding layer would be larger.

In comparison, in some embodiments of the present disclosure, the semiconductor layer of the transistor can be shielded by the touch signal line (i.e. the conductive layer) rather than a light-shielding layer disposed over another substrate. Since only the alignment error between the mask of the touch signal line and the mask of the semiconductor layer (which is smaller than the error of assembly between the first substrate and another substrate, for example, 0.5 times the error of assembly between the first substrate and another substrate) has to be taken into consideration when deciding the area of the touch signal line, and the error of assembly between the first substrate and another substrate may not to be taken into consideration, the area of the touch signal line (i.e. the conductive layer) may be smaller. In addition, since the light-shielding layer disposed over another substrate may not need to shield the semiconductor layer, the area of this light-shielding layer may also be smaller. Therefore, the aperture ratio and the transmittance of the display device may also be increased.

In some embodiments of the present disclosure, the touch signal line 120 (or the conductive layer 120) may cover the entire semiconductor layer 116.

In addition, as shown in FIG. 4B, the planar layer 130 has an opening 130A2, and the opening 130A2 has the slanted side. The pixel electrode 122 is electrically connected to the transistors 110 through the opening 130A2 and the opening 128A2 in the first insulating layer 128. As shown in FIGS. 4A-4B, in some embodiments of the present disclosure, the conductive layer 120 (for example, the touch signal line 120) at least partially overlaps the first opening 130A2 of the planar layer 130. For example, the touch signal line 120 may cover the first opening 130A2 of the planar layer 130.

The light leakage at the region at the opening 130A2 of the planar layer 130 may result due to the nonplanar surface of the layer. Therefore, in the conventional display device, the light-shielding layer disposed over another substrate which is disposed opposite the first substrate (for example, the subsequent light-shielding layer 146 disposed over the second substrate 140) is used to shield the opening of the planar layer. However, in order to ensure that the light-shielding layer may shield the opening of the planar layer, the error of assembly between the first substrate and another substrate must be taken into consideration when deciding the area of the light-shielding layer. Therefore, the area of the light-shielding layer would be larger.

In comparison, in some embodiments of the present disclosure, the opening of the planar layer is shielded by the touch signal line (i.e. the conductive layer) rather than a light-shielding layer disposed over another substrate. Since only the alignment error between the mask of the touch signal line and the mask of the opening of the planar layer (which is smaller than the error of assembly between the first substrate and another substrate, for example, 0.5 times the error of assembly between the first substrate and another substrate) has to be taken into consideration when deciding the area of the touch signal line, and the error of assembly between the first substrate and another substrate may not to be taken into consideration, the area of the touch signal line (i.e. the conductive layer) may be smaller. In addition, since the light-shielding layer disposed over another substrate may not need to shield the opening of the planar layer, the area of this light-shielding layer may also be smaller. Therefore, the aperture ratio and the transmittance of the display device may also be increased.

In some embodiments of the present disclosure, the touch signal line 120 (i.e. the conductive layer 120) may cover the entire first opening 130A2 of the planar layer 130.

Still referring to FIG. 4A, the semiconductor layer 116 has a first side 116S1 and a second side 116S2, and the first side 116S1 and the second side 116S2 are opposite to each other. The shortest distance between the first side 116S1 and the edge 120E (for example, the edge 120E1) of the touch signal line 120 (i.e. the conductive layer 120) is the first distance D1, and the shortest distance between the second side 116S2 and the edge 120E (for example, the edge 120E2) of the touch signal line 120 (i.e. the conductive layer 120) is the second distance D2.

In addition, the first opening 130A2 has a third side 130S1 and a fourth side 130S2, and the third side 130S1 and fourth side 130S2 are opposite to each other. The shortest distance between the third side 130S1 and the edge 120E (for example, the edge 120E3) of the touch signal line 120 (i.e. the conductive layer 120) is the third distance D3, and the shortest distance between the fourth side 130S2 and the edge 120E (for example, the edge 120E4) of the touch signal line 120 (i.e. the conductive layer 120) is the fourth distance D4. The third distance D3 may be greater than the first distance D1 and the second distance D2, and the fourth distance D4 may be greater than the first distance D1 and the second distance D2.

In addition, the first side 116S1 and the second side 116S2 of the semiconductor layer 116 are the sides of the semiconductor layer 116 which extend along the gate-line extending direction A1. The third side 130S1 and fourth side 130S2 of the opening 130A2 are sides of the opening 130A2 which extend along the gate-line extending direction A1. The aforementioned shortest distances are the shortest distances measured along the direction A2. In other words, the first distance D1, the second distance D2, the third distance D3 and the fourth distance D4 are distances extend along the same direction.

The sides of the opening 130A2 in FIG. 4A are drawn according to the edge at the bottom of the opening 130A2 in FIG. 4B. According to some embodiments of the present disclosure, the sides of the opening 130A2 may be slanted sides shown in FIG. 4B. In other words, the opening 130A2 expands or broadens from its bottom to its top. Therefore, the top portion of the opening 130A2 is slightly larger than the sides drawn in FIG. 4A. Therefore, the touch signal line 120 (i.e. the conductive layer 120) may need larger area to shield the opening 130A2. In other words, the third distance D3 and the fourth distance D4 may need to be larger.

However, since the sides of the semiconductor layer 116 drawn in FIG. 4A are the sides of the semiconductor layer 116 drawn in FIG. 4B, the sides of the semiconductor layer 116 are not slanted sides in usual. Therefore, the touch signal line 120 (i.e. the conductive layer 120) may shield the semiconductor layer 116 without larger area. Therefore, in some embodiments of the present disclosure, the third distance D3 may be greater than the first distance D1 and the second distance D2, and the fourth distance D4 may be greater than the first distance D1 and the second distance D2.

In some embodiments of the present disclosure, the fourth distance D4 may be greater than or equal to the third distance D3. For example, in some embodiments of the present disclosure, as shown in FIG. 4A, the fourth distance D4 is greater than the third distance D3. However, it should be noted that in addition to the embodiment set forth in FIG. 4A, the fourth distance D4 may be equal to the third distance D3.

In addition, as shown in FIG. 4C, the common electrode 132 is electrically connected to the touch signal line 120 (i.e. the conductive layer 120) through the opening 138A3. The opening 138A3 is disposed in the second insulating layer 134 and/or the third insulating layer 138. For example, in this embodiment, the opening 138A3 is disposed in the third insulating layer 138. In addition, as shown in FIG. 4B, the pixel electrode 122 is electrically connected to the transistor 110.

In addition, in some embodiments of the present disclosure, as shown in FIG. 4A, the second opening 138A3 does not overlap the first opening 130A2.

In addition, still referring to FIGS. 4B-4C, display device 400 can further include a second substrate 140 disposed opposite the array substrate 102, and a display medium 142 disposed between the array substrate 102 and the second substrate 140.

In some embodiments of the present disclosure, the second substrate 140 can be a color filter substrate. In particular, the second substrate 140, which serves as a color filter substrate, may include a substrate 144, a light-shielding layer 146 disposed over the substrate 144, a color filter layer 148 disposed over the light-shielding layer 146, and a protection layer 150 covering the light-shielding layer 146 and the color filter layer 148.

The substrate 144 may include a transparent substrate such as a glass substrate, a ceramic substrate, a plastic substrate, or any other suitable transparent substrate. The light-shielding layer 146 may include, but is not limited to, black photoresist, black printing ink, black resin. The color filter layer 148 may include a red color filter layer, a green color filter layer, a blue color filter layer, or any other suitable color filter layer.

The display medium 142 may be a liquid-crystal material. The liquid-crystal material may include, but is not limited to, nematic liquid crystal, smectic liquid crystal, cholesteric liquid crystal, blue phase liquid crystal, or any other suitable liquid-crystal material.

In addition, in some embodiments of the present disclosure, as shown in FIG. 4A, the edge of the light-shielding layer 146 may be aligned to the edge or side of the touch signal line 120 (i.e. the conductive layer 120). For example, in some embodiments of the present disclosure, the edge 146E1 of the light-shielding layer 146 may be aligned to the edge 120E3 of the conductive layer 120, and the edge 146E2 of the light-shielding layer 146 may be aligned to the edge 120E4 of the conductive layer 120.

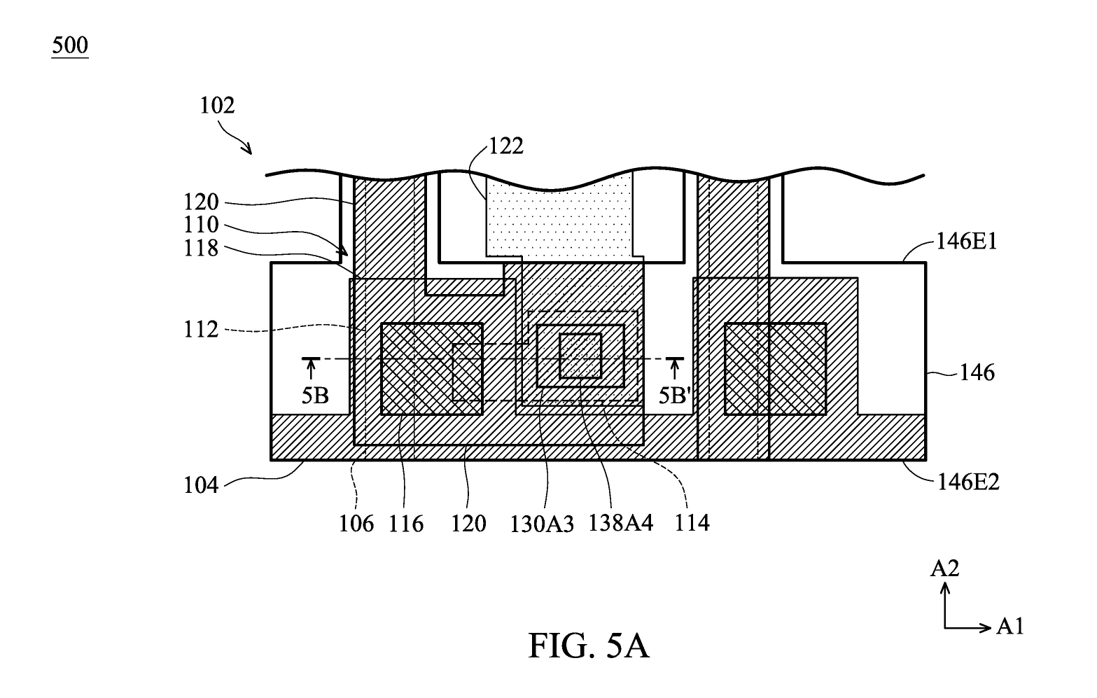

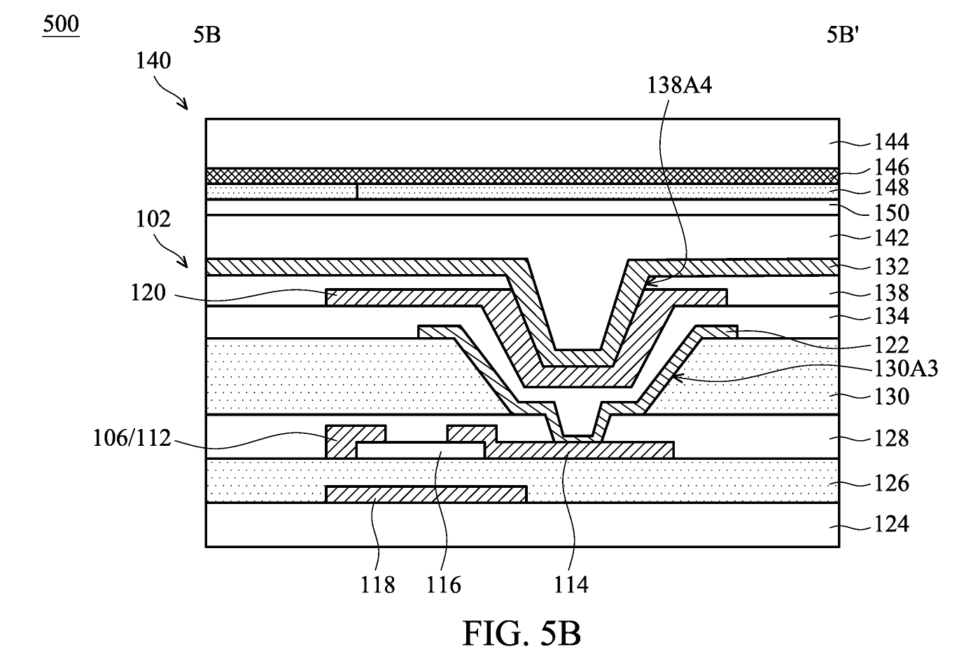

It should be noted that the exemplary embodiment set forth in FIGS. 4A-4C is merely for the purpose of illustration. Although in the embodiments shown in FIGS. 4A-4C, the second opening 138A3 does not overlap the first opening 130A2, in some other embodiments of the present disclosure, the opening 138A3 may overlap the opening 130A2, as shown in FIGS. 5A-5B. This will be described in detail in the following description. Therefore, the inventive concept and scope are not limited to the exemplary embodiment shown in FIGS. 4A-4C.

FIG. 5A is a top view of an array substrate 102 of the touch display device 500 in accordance with some embodiments of the present disclosure. FIG. 5B is a cross-sectional view along line 5B-5B′ in FIG. 5A in accordance with some embodiments of the present disclosure. The difference between the embodiment shown in FIGS. 5A-5B and the embodiment shown in FIGS. 4A-4C is that the second opening 138A4 of the third insulating layer 138 and the first opening 130A3 of the planar layer 130 at least partially overlap each other. The common electrode 132 is electrically connected to the touch signal line 120 through the second opening 138A4, and the pixel electrode 122 is electrically connected to the transistor 110 through the first opening 130A3.

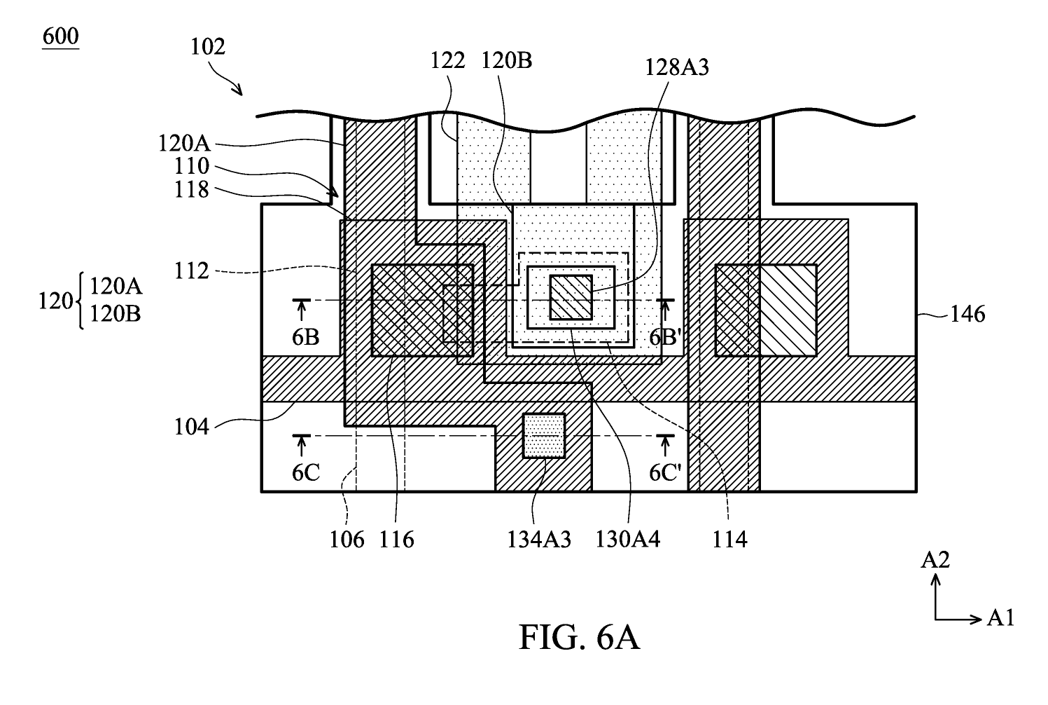

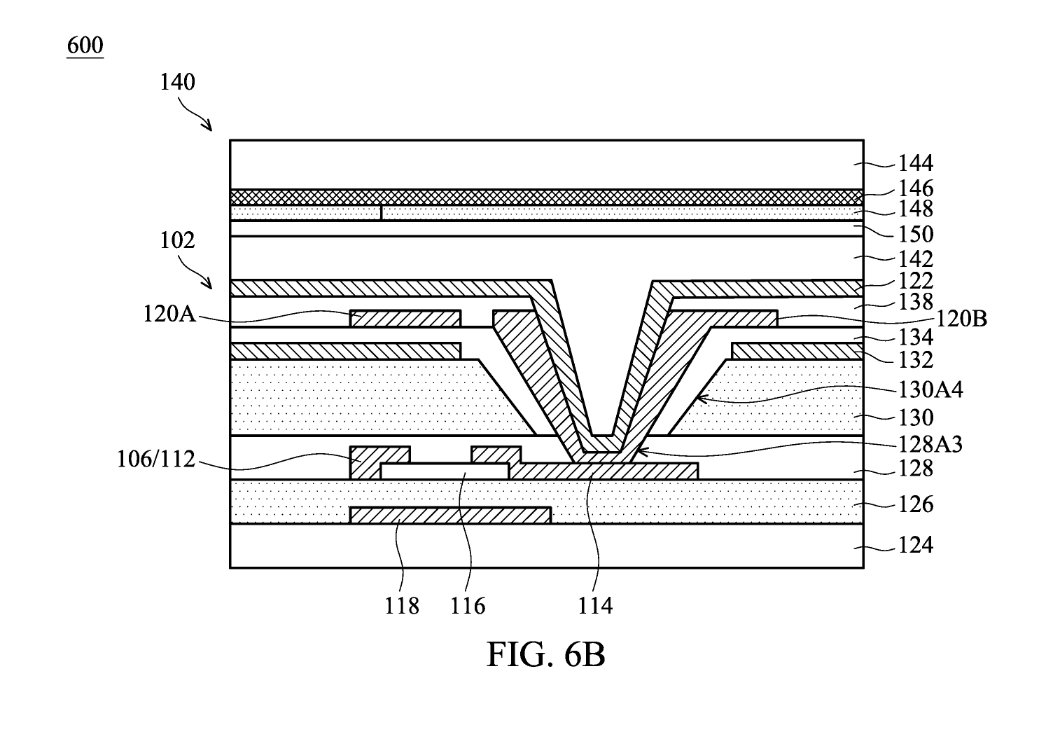

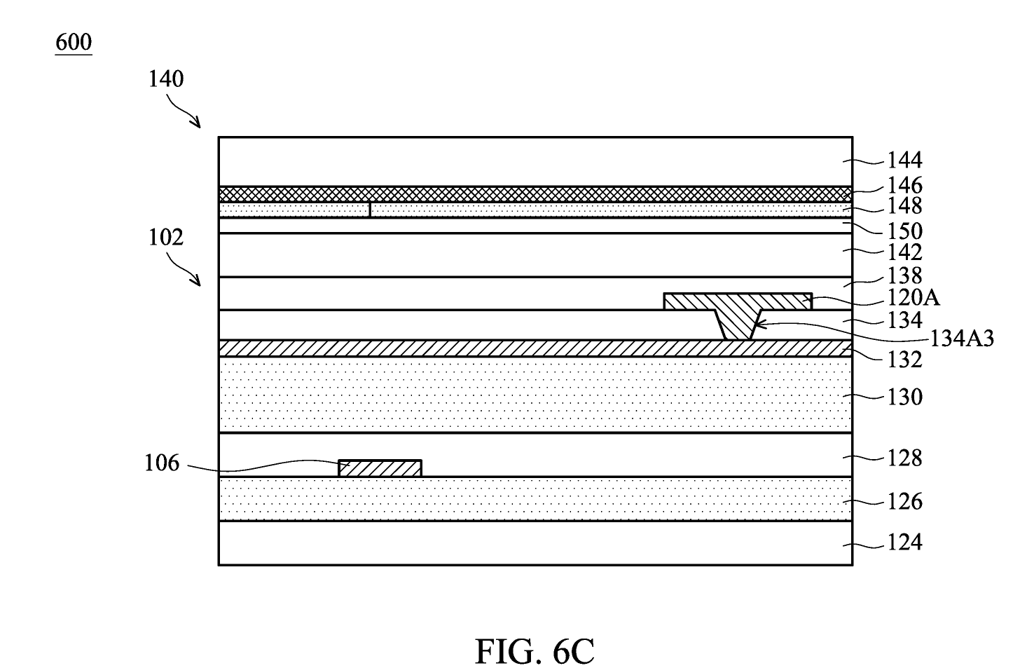

It should be noted that the exemplary embodiments set forth in FIGS. 4A-5B are merely for the purpose of illustration. In addition to the embodiments set forth in FIGS. 4A-5B, the pixel electrode and common electrode of the present disclosure may have other configurations as shown in FIGS. 6A-6C. This will be described in detail in the following description. Therefore, the inventive concept and scope are not limited to the exemplary embodiments shown in FIGS. 4A-5B.

FIG. 6A is a top view of an array substrate 102 of the touch display device 600 in accordance with some embodiments of the present disclosure. FIG. 6B is a cross-sectional view along line 6B-6B′ in FIG. 6A in accordance with some embodiments of the present disclosure. FIG. 6C is a cross-sectional view along line 6C-6C′ in FIG. 6A in accordance with some embodiments of the present disclosure. The difference between the embodiment shown in FIGS. 6A-6C and the embodiment shown in FIGS. 4A-5B is that the pixel electrode 122 is disposed over the common electrode 132. In addition, the conductive layer 120 includes a first portion 120A and a second portion 120B. The first portion 120A is the touch signal line, and the second portion 120B is a conductive shielding layer.

In particular, referring to FIG. 6A, the touch signal line 120A and the conductive shielding layer 120B of the conductive layer 120 are electrically insulated from each other. In addition, the touch signal line 120A overlaps the semiconductor layer 116, and the conductive shielding layer 120B overlaps the first opening 130A4.

As shown in FIG. 6B, the conductive shielding layer 120B of the conductive layer 120 is electrically connected to the pixel electrode 122, and the pixel electrode 122 is electrically connected to the transistor 110 through the conductive shielding layer 120B and the opening 128A3 of the first insulating layer 128.

As shown in FIG. 6C, the touch signal line 120A of the conductive layer 120 is electrically connected to the common electrode 132 through the second opening 134A3 of the second insulating layer 134. The second opening 134A3 is disposed in the second insulating layer 134.

In summary, according to some embodiments, by having the touch signal line at least partially overlap the pixel electrode, the storage capacitor of the touch display device can be increased, thus reducing the risk of inferior display quality of the touch display device. In addition, in some embodiments of the present disclosure, the semiconductor layer of the transistor and the opening of the planar layer are shielded by the touch signal line (i.e. the conductive layer), rather than the light-shielding layer disposed over another substrate. Therefore, the area of this light-shielding layer may be smaller, and the aperture ratio and the transmittance of the display device may also be increased.

In addition, it should be noted that the drain and source mentioned above in the present disclosure are switchable since the definition of the drain and source is related to the voltage connecting thereto.

Note that the above element sizes, element parameters, and element shapes are not limitations of the present disclosure. Those skilled in the art can adjust these settings or values according to different requirements. It should be understood that the touch display device and method for manufacturing the same of the present disclosure are not limited to the configurations of FIGS. 1A to 6C. The present disclosure may merely include any one or more features of any one or more embodiments of FIGS. 1A to 6C. In other words, not all of the features shown in the figures should be implemented in the touch display device and method for manufacturing the same of the present disclosure.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A touch display device, comprising:
a first substrate;
a transistor disposed over the first substrate;
a first insulating layer disposed over the transistor;
a first electrode disposed over the first insulating layer;
a second insulating layer disposed over the first electrode;
a conductive layer disposed over the second insulating layer, wherein the conductive layer comprises a touch signal line;
a third insulating layer disposed over the conductive layer; and
a second electrode disposed over the third insulating layer,
wherein one of the first electrode and the second electrode is electrically connected to the touch signal line,
wherein another one of the first electrode and the second electrode is electrically connected to the transistor and at least partially overlaps the conductive layer.

2. The touch display device as claimed in claim 1,
wherein the first electrode is electrically connected to the touch signal line,
wherein the second electrode is electrically connected to the transistor and at least partially overlaps the conductive layer.

3. The touch display device as claimed in claim 1,
wherein the first electrode is electrically connected to the transistor and at least partially overlaps the conductive layer,
wherein the second electrode is electrically connected to the touch signal line.

4. The touch display device as claimed in claim 1, wherein the conductive layer at least partially overlaps the transistor.

5. The touch display device as claimed in claim 4, wherein the transistor comprises a semiconductor layer, wherein an overlapping region between the conductive layer and the transistor comprises the semiconductor layer.

6. The touch display device as claimed in claim 5, further comprising:
a planar layer disposed between the first insulating layer and the second insulating layer, wherein the planar layer comprises a first opening,
wherein the first electrode or the second electrode is electrically connected to the transistor through the first opening.

7. The touch display device as claimed in claim 6, wherein the conductive layer at least partially overlaps the first opening.

8. The touch display device as claimed in claim 7,
wherein the semiconductor layer has a first side and a second side, and the first side and the second side are opposite to each other,
wherein a shortest distance between the first side and an edge of the conductive layer is a first distance, and a shortest distance between the second side and the edge of the conductive layer is a second distance,
wherein the first opening has a third side and a fourth side, and the third side and the fourth side are opposite to each other,
wherein a shortest distance between the third side and the edge of the conductive layer is a third distance, and a shortest distance between the fourth side and the edge of the conductive layer is a fourth distance,
wherein the first distance, the second distance, the third distance and the fourth distance are distances extend along same direction,
wherein the third distance is greater than the first distance and the second distance, wherein the fourth distance is greater than the first distance and the second distance.

9. The touch display device as claimed in claim 6,
wherein the second insulating layer or the third insulating layer has a second opening,
wherein one of the first electrode and the second electrode is electrically connected to the touch signal line through the second opening.

10. The touch display device as claimed in claim 9, wherein the second opening does not overlap with the first opening.

11. The touch display device as claimed in claim 9, wherein the second opening and the first opening at least partially overlap with each other.

12. The touch display device as claimed in claim 9,
wherein the conductive layer further comprises a conductive shielding portion, wherein the touch signal line is electrically insulated from the conductive shielding portion,
wherein the touch signal line overlaps the semiconductor layer, and the conductive shielding portion overlaps the first opening.

13. The touch display device as claimed in claim 12, wherein the second opening is disposed in the second insulating layer,
wherein the touch signal line is electrically connected to the first electrode through the second opening,
wherein the conductive shielding portion is electrically connected to the second electrode.

14. The touch display device as claimed in claim 1, further comprising:
a second substrate disposed opposite the first substrate; and
a display medium disposed between the first substrate and the second substrate.
